(19) United States
(12) Patent Application Publication
(10) Pub. No.: US 2013/0168160 A1
(43) Pub. Date: Jul. 4, 2013

(54) Weight Change as a Measurement of an Intrinsic Energy Property of Matter

(71) Applicant: William John Martin, South Pasadena, CA (US)

(72) Inventor: William John Martin, South Pasadena, CA (US)

(21) Appl. No.: 13/340,669

(22) Filed: Dec. 29, 2011

(51) Int. Cl. G01G 9/00

(52) U.S. Cl. 177/1

(57) ABSTRACT

Many fluids, including water and alcohols, have a novel and biologically beneficial, energy-related quality, levels of which can differ between samples of the same fluid. It was shown previously, that this activity could be monitored using a neutral red kinetic assay (NR-kinetic assay). It is now disclosed that this activity also correlates with a reduction in measured weight of a fluid, possibly related to reduced responsiveness to the force of gravity. It is postulated that a reciprocal relationship may exist between responsiveness to gravity (G-force) and another form of universally available energy, tentatively termed the L-force. The responsiveness to the L-force, rather than or in addition to a direct transmission of this energy, is physically transferrable between fluids even without physical contact of the fluids.

### CROSS REFERENCE TO RELATED APPLICATIONS

### Co-Pending Patent Application

Methods for detection of ultraviolet light reactive alternative cellular energy pigments (ACE-pigments). William John Martin Submitted Dec. 24, 2007. Publication number 20090163831 Method of assessing and of activating the alternative cellular energy (ACE) pathway in the Therapy of Diseases. William John Martin Submitted Jan. 16, 2008. Publication number 20090181467

Enerceutical mediated activation of the alternative cellular energy (ACE) pathway in the therapy of diseases. Submitted May 8, 2008. Publication number 20090280193

Regenerative wound healing using copper-silver citrate composition. Publication number: 20100099758 Submitted Oct. 22, 2008.

Enerceutical activation of the alternative cellular energy (ACE) pathway in therapy of diseases. Submitted Feb. 11, 2009. Publication number 20090202442

Method of using the body's alternative cellular energy pigments (ACE-pigments) in the therapy of diseases Submitted Feb. 20, 2009. Publication number 20100215763

Urine as a source of alternative cellular energy pigments (ACE-pigments) in the assessment and therapy of diseases. Submitted Mar. 5, 2009. Publication number 20100196297

Moringa oil mediated activation of the alternative cellular energy pathway in the therapy of diseases. Submitted Feb. 24, 2010. Publication number 20110208110

Diagnostic value of systemic ACE pathway activation in the detection by fluorescence of localized pathological lesions. Submitted Jul. 26, 2010. Publication number 20100291000

Enerceutical mediated activation of the alternative cellular energy (ACE) pathway in the therapy of diseases. Submitted July 2010.

Energy Charged Liquids to Enhance Enerceutical Activation of the Alternative Cellular Energy (ACE) Pathway in the Therapy of Diseases. Submitted Dec. 17, 2010. Application Ser. No. 12/972,344

Energy Charged Alcoholic Beverages for Enhancing the Alternative Cellular Energy Pathway in the Prevention and Therapy of Diseases. Submitted January 2011.

Methods for Detecting and Monitoring the Activity of Energized Water and Other Liquids Useful for Enhancing the Alternative Cellular Energy Pathway in the Prevention and Therapy of Diseases. Submitted February 2011

Methods for Increasing the Kinetic Activity of Alcohol, Water and Other Liquids, so as to Render the Liquids More Useful in Enhancing the Alternative Cellular Energy Pathway in the Prevention and Therapy of Diseases. Submitted February 2011

Methods for Increasing the Kinetic Activity of Water and Other Liquids, so as to Render the Liquids More Useful in Enhancing the Alternative Cellular Energy Pathway and in Various Other Agricultural and Industrial Applications. Submitted June 2011.

Methods for Increasing the Kinetic Activity of Water and Other Liquids, so as to Render the Liquids More Useful in Enhancing the Alternative Cellular Energy Pathway and in Various Other Agricultural and Industrial Applications. Submitted October 2011.

Use of Plants Extracts to Activate Water, Alcohol and Other Liquids. Submitted Oct. 27, 2011. Application Ser. No. 13/272,215.

Methods of Transferring Energies to Water, Alcohols and minerals. Submitted Nov. 25, 2011. Application Ser. No. 13/304,558.

### STATEMENT REGARDING FEDERALLY SPONSORED RESEARCH OR DEVELOPMENT

Not applicable: No Federal funding was received in support of this patent application.

### REFERENCE TO SEQUENCE LISTING, A TABLE OR A COMPUTER PROGRAM LISTING COMPACT DISK APPENDIX

Not applicable.

### BACKGROUND OF THE INVENTION

A method has been developed to detect and assess an energy property of water and other fluids. It is based on the differing interactions, which can be seen microscopically when a few particles of neutral red dye are sprinkled onto the surface of the fluid. Especially, with water, a clear distinction can be observed between the relatively slow formations of concentrically expanding dye from individual, stationary particles and varying levels of a more rapid and linear streaking of the dissolving dye, with discernable additional movements of some of the remaining, un-dissolved neutral red dye. In water samples with a high level of reactivity with neutral red dye, the resulting solution will commonly also show fluorescence, not attributable to a high pH, when the solution is illuminated with an ultraviolet (UV) light (for example a proLume 15 watt spiral light bulb).

The simplicity of this neutral red kinetic assay (NR-kinetic assay) has facilitated the development of various methods to induce a positive responsiveness in otherwise inactive or poorly reactive water samples. Furthermore, clinical benefits have been observed from consuming “energized” water, beyond those seen with neutral red un-reactive water.

The linear dissolving pattern of neutral red dye is seen when neutral red dye is sprinkled onto alcohols, including absolute ethanol and alcoholic spirit beverages. Again, however, the speed and vigor of the interaction of neutral red dye with alcohols, as well as the intensity of UV fluorescence, can be greatly enhanced using various activation procedures as detailed in the co-pending patent applications, which are incorporated by reference herein.

A very striking observation using the NR-kinetic assay with energized ethanol is the formation of focal clusters of the remaining fine particles of un-dissolved neutral red dye, from which individual particles can be rapidly ejected only to more slowly return towards the cluster, only to be ejected again and again. These movements are enhanced by the heat and the light of the microscope, but go well beyond any suggestion of simply following convention currents. Another important observation is that illuminated, energized ethanol with added neutral red dye, can enhance the NR-kinetic assay in regular water by simply being placed close to the water and without any actual mixing of the solutions. In on e such embodiment, the activated water is being subsequently used for beneficial human consumption. It would appear that illuminated, activated ethanol with neutral red dye solution is radiating an energy field, which can influence the long-term energy status of nearby fluids.

The question arises as to the source(s) of energy responsible for the dynamic, linear dissolving patterns of neutral red dye in energized solutions, the to-and-fro movements of un-dissolved fine particles and the distant effects on other fluids. Many pioneers, including Anton Mesmer (1734-1815; Baron Carl Reichenbach (1771-1826); James Clark Maxwell (1831-1879); Nikola Tesle (1856-1943); Wilhelm Reich (1897-1957) and others have suggested various forms of non-conventional energies may exist within Nature. Some of these energies may be of a scalar quality without a vector (directional) component and are, therefore, difficult to capture and effectively measure.

Of the more conventional forms of natural energies, gravity is the least understood. While it is commonly equated with a pulling force operating between physical objects, more elaborate theories propose that objects can distort the space-time relationship with an inwardly directed propensity of movements of objects towards each other. The extent of the distortion is in direct proportion to the mass of an object as measured by its weight. Levitation refers to a process of overcoming the force of gravity and is most readily demonstrated using a counterbalancing magnetic force, as can occur with a magnet paced in the vicinity of a superconductor with diamagnetic properties. The magnetism repelling force of a superconductor is referred to the Meissner field effect and is associated with the hypothetical formation of pairs of electrons, which together lack any net angular momentum. Whole atoms can also functionally behave as unitary entities, especially at extremely low temperatures, as with Bose-Einstein condensates and, thereby, assume superconducting and levitating properties. Mr. David Hudson has informally reported that monatomic forms of platinum-group minerals, obtained by using pH-controlled precipitation materials derived from certain types of soils, can lose nearly half of their weight when heated to certain high temperatures. Mr. Hudson has attributed the weight changes to monatomic minerals acquiring superconducting properties at these temperatures.

The concepts of levitation and weightlessness have also become part of mystical folklore. It has also been considered, but not proven, that massive objects without any magnetic properties may have somehow been levitated in the construction of ancient monuments, such as the Pyramids, Stonehenge and Coral Castle.

I have reviewed the science of gravity and have sided with the very unconventional view that a force density varies inversely to the distance from an object as a consequence of the force being continually consumed by the object, when it exists in its normal state. A lightweight object placed above a more massive object will tend to be pushed downward by the inverse gradient of the density of the gravity force. It can be further argued, that abnormal states of matter may exist, which fail to absorb or to be influenced by the force of gravity. This principle is different from Meissner field effect in which gravity persists but is simply counterbalanced by a magnetic force. It follows from my reasoning that if an object changes from its normal state towards becoming refractory to gravity, its measured weight would progressively decrease and this should be relatively easy to measure.

The object of the present invention was, therefore, to explore the possibility that energized water and other fluids may have an altered responsiveness to the downward force of gravity and, therefore, show a reduction in weight. If so, changes in weight could be used as an auxiliary measure to the NR-kinetic assay to monitor, quantify and further develop various fluid activation processes. This application is an extension of the listed co-pending patent applications, which are incorporated by reference into the present application.

### BRIEF SUMMARY OF THE INVENTION

The measured weight of fluids is significantly reduced by various activation processes, which have previously shown to enhance the activity of the fluids when assessed using the NR-kinetic assay. Reductions in fluid weight of from 2 to 5 mg/ml have occurred in some of these experiments. Activation cannot only be achieved by directly treating the fluid, but can be induced by the presence of activated fluid in the vicinity of a test sample. The data are consistent with molecular alterations occurring in the test fluids, manifested in part by a reduced susceptibility to a downward acting gravity force. While the initial weight reduction may be a direct result of energy absorbed at the time of activation, it is also possible that the initial activation process triggers a progressive reaction in which other molecules become transformed. This can explain the slow, yet steady decline in weight, even over the period of an hour, following removal of an external energy-activating device. The measurement of weight change provides an extremely valuable marker for potential biological activity of activated fluids and of the potency and effectiveness of activation methods. It should also help in the more precise characterization of gravity and of the molecular activating forces.

### BRIEF DESCRIPTION OF THE DRAWINGS

Not Applicable and none included

### DETAILED DESCRIPTION OF THE INVENTION

Various procedures have been used either alone or in various combinations to achieve ethanol activation, as assessed using the NR-kinetic assay. For many studies, the ethanol activation process merely consisted of placing a sealed Zip-Loc plastic bag containing previously activated ethanol to which approximately 0.1 mg/ml of neutral red dye had been freshly added, into a wide-mouth open container of regular ethanol, and illuminating the Zip-Loc bag with ultraviolet light for several hours. Two-hundred-proof ethanol (Sigma-Aldrich catalogue number 493546) was commonly used, although high ethanol content alcoholic beverages, such as Ever-Clear (75.5% alcohol in California) were also routinely used, as were methanol and isopropyl alcohol. Note that various other procedures can be used separately or in various combination with the UV illuminated previously activated ethanol plus neutral red dye method described above. These additional methods include bubbling of gasses generated by the electrolysis of water, which include Brown's gas or what I referred to as Water Gas; addition of leaf and/or seed powder from moringa plants; addition of magnesium oxide beads to the ethanol; using certain ceramic or volcanic stones and minerals such as tourmaline, germanium and mica. The NR-kinetic assay has been helpful in evaluating the effectiveness of all of these various procedures. The question posed in the present application is whether the measurement of weight loss might provide an alternative assay method for distinguishing activated from regular ethanol and further used to assess the activation levels of other fluids, including water.

The initial experiments involved nearly completely filling leak-proof plastic 1 and 2 oz plastic bottles with either unprocessed or energy activated ethanol, accurately weighing the filled bottles by placing in onto a sensitive balance scale (Sartorius 200 gram digital balance measuring to the nearest 0.1 mg). A determination was made as to whether the indicated weight was essentially stable, fluctuating by far less than 1 mg, or would show a slight but continuing decrease in the indicated weight. The latter was clearly observed using recently activated samples of ethanol. Rather than providing a steady reading with fluctuations well less than 1 mg, the shown weight progressive declined over a 30 minute period, before reaching a level from which there was comparable small increases and decreases, beyond the typically very stable reading with most items being weighed.

To exclude an artifact of the electronic balance, a filled and sealed 200 ml glass container of freshly activated ethanol was weighed using a Triple Beam Balance (Ohaus Scale Company Union New Jersey). It weighs to 2,610 grams, and is sensitive to <0.1 gram. After several hours, the beam was clearly depressed from the initial horizontal position and required a lower adjustment of 0.45 grams for the beam to rise to the exact horizontal position.

In the next series of experiments, earlier activated batches of ethanol, whose weight was essentially steady unless jolted, were placed onto the Sartorius scale and accurately measured to 0.1 mg. A small quantity of neutral red dye (approximately 0.1 mg/ml) was added to the ethanol and the lid of the leak-proof container tightly secured. The ethanol plus neutral red dye solution quickly began to show a progressive decrease in its weight. The decline continued beyond 30 minutes and its rate could be increased by UV illumination using either a 15-watt Prolume bulb or even more so using a 100-watt Sylvania bulb. Even without measuring an initial rapid fall in weight, the reduction in weight while the sample remained on the balance would typically exceed 0.2 mg/ml/minute for 10 to 20 minutes.

In a similar series of studies, freshly activated water (produced as initially described above for ethanol) and water, which had been earlier activated and stored for over a week, were weighed before and after the addition of neutral red dye. While not as fast as with activated ethanol, considerable progressive weight reductions were observed. Typically, within an hour a reduction of 2-5 mg/ml of activated water samples was observed using neutral red dye and UV illumination. Progressive weight reduction was also achieved using closed glass containers and without UV light. Once the final weight reduction was achieved, it was possible to decant over half of the fluid and replace it with fresh regular fluid. Upon replacing the container onto the scale, its weight was again noted to begin to fall, indicating that the newly added water was becoming activated. It appears, therefore, that the fluid activation can be a progressive process with previously activated molecules able to activate other molecules. This capacity of being able to repeatedly energize newly added water is also indicative of an externally acting additional energy source. It is conceivable that the activated fluids are more responsive than regular fluids to several sources of external energy, including electromagnetic radiation, magnetism and sound. What is particularly intriguing is the induced responsiveness to an unconventional energy, currently being termed the L-force.

The question was then asked if an activated ethanol or water sample could impart the progressive weight reducing property to other fluids by simply being placed in the vicinity of the other fluid. A sample of water, ethanol or alcoholic beverage was placed onto the electronic scale and its steady weight recorded. I sample of activated ethanol with or without neutral red dye was placed into the vicinity of the scale and later removed. The test sample on the scale would commonly begin to show a slow and steady weight decline, which continued after removal of the neutral red activated sample. Both water and ethanol could be distantly activated. Indeed, in doing these studies, it was necessary to place the balance scale in a room separate from where activated solutions were commonly prepared and stored. It is also possible that individuals may be a source of radiant energy, which may affect the intrinsic energy properties of fluids and other materials. Experiments are planned in collaboration with Reiki masters, etc., to see if they have the capacity to slightly, but significantly, reduce the measured weight of fluids.

As detailed in the co-pending patent applications, a major impetus for these studies has been the use of activated solutions, whether applied to the surface of the skin or consumed to enhance the alternative cellular energy (ACE) pathway of humans, and by inference animals and plants. The present, easily quantifiable findings of measured weight reduction provide an important insight into the ACE pathway. The human body is mainly composed of water and the weight reduction assay can be easily applied to blood, urine, saliva and other body fluids. It is known, for example, that urine and saliva from an autistic child fluoresces strongly when mixed with neutral red dye. It is expected that this reaction may also be accompanied by a reduction in the measured weight of the fluid.

The question was asked if the measured weight of solid materials could also be reduced by a distantly acting energy emanating from activated fluids. I had previously shown that moringa leaf and seed powder and magnesium oxide beads were enhanced in their capacity to activate ethanol solutions, by simply being exposed to UV illuminated sealed plastic ZipLoc bags containing activated ethanol plus neutral red dye. Not surprising, therefore, slight declines of the recorded weights of both moringa leaf powder and magnesium oxide beads were recorded. What was also noted is that the 100 watt Sylvania UV light alone caused a major, but quickly reversible weight reduction of samples of moringa leaf and seed powders and moringa leaf oil. These products represent energizing foods and dietary supplements, which I have referred to as enerceuticals. The weight reducing of using UV illuminated, activated alcohol plus neutral red dye, or of using direct UV illumination effect was not seen using several examples of processed foods and other unrelated objects.

The loss of measured weight of water, ethanol and other fluids was further used to directly test the activation properties of various procedures, previously assessed using the NR-kinetic assay. Typically, I would use approximately 70 ml of fluid in a leak-proof plastic container of the fluid. At least 3.5 mg reduction in the measured weight was regarded as being significant. Using this criteria, several tested compounds were deemed to be active, including a Japanese extracts of tree sap called HB-101, volcanic stones marked as Kiko Stones, kaolin clay marketed as an Intrasound Activated Product and developed by Victor Roehrich; marketed plant extracts; zeolites and humic/fulvic acids. It was also noted that succussion of a sealed homeopathic solution, referred to as Enercel, would trigger a significant, although minor, progressive reduction in the measured weight of the solution.

The standard water assay is developed to record the rate and the extent of measured weight reduction in water packaged into a case of 24 bottles and stored separately from the location of conducting the actual weighing experiment. Correlations are also being established using the level of weight reduction and activity in the NR-kinetic assay. The standard ethanol assay is similarly being used to record the rate and extent of measured weight reduction in separately stored bottles of Ever Clear alcoholic beverage. Other assays are being standardized for other fluids, including gasoline.

The use of the weight reduction and what will be referred to in the future as the L-force assay is not dependent upon a complete or even necessarily accurate explanation of the underlying science. Ongoing studies are indicating various changes in electrical conductivity and in electrical energy generation within activated fluids, including water. A major value of the present invention is the ease and quantitative exactness of measuring weight. Predictably, one will be able to monitor wellness as a weight component of the constituents of living creatures. It is further predicted that water, which is better able to absorb L-force, will be more efficient in mediating various life processes, such as allowing enzymes to work more efficiently. There are many other ramifications from linking L-force to the natural healing capacity of humans, animals and plants, especially in response to wounds and infections, not effectively addressed by the immune system. The use and application of the information and methods disclosed in this patent application will facilitate further progress in healthcare and basic physics and biology.

While this invention has been disclosed with reference to specific embodiments, it is apparent that others skilled in the art may devise other embodiments and variations of this invention without departing from the basic spirit and scope of the invention. The appended claims are restricted for the purpose of avoiding having to make subsequent elections of only some of the claims. Many other claims can and should be made on the information disclosed herein. The present claims on this application are as follows:

1. A method for detecting the acquisition of an intrinsic energy property by various materials, comprising determining at varying time periods, whether there is a significant, although minor, progressive reduction in the measured weight of the material, which is not attributed to an actual loss of any material, and is consistent with a reduced sensitivity of the material to gravity, as the consequence of the acquisition of the energy property.

2. An assay to detect the ability of a procedure and/or an energy force, to impart an intrinsic energy property into various materials, comprising determining, at various time periods, whether the procedure and/or energy force can cause a significant, although minor, progressive reduction in the measured weight of the material, which is not attributed to an actual loss of any material, and is consistent with a reduced sensitivity of the material to gravity as the consequence of the acquisition of the energy property.

3. The method of claim 2 applied to the detection of an energy force within an environment, including possibly emanating from an individual; the energy force being detected is that which is able to impart an intrinsic energy property into various materials, comprising determining at varying intervals, whether placing of the material into the environment to be tested, leads to a significant, although minor, progressive reduction in the measured weight of the material, which is not attributed to an actual loss of any material, and is consistent with a reduced sensitivity of the material to gravity as the consequence of the acquisition of the energy property from the tested environment.

4. The method of claim 1, to determine the stability of an intrinsic energy property acquired by various materials comprising determining over time if there is any reversal of the weight reduction, which occurred at the time that the intrinsic energy had been acquired by a material and the weight gain is not attributed to addition of any new material, but rather is consistent with the material regaining the level of sensitivity to gravity, which it had previously lost as the consequence of having acquired the intrinsic energy property.

5. The method of claim 1, in which the material is a fluid

6. The method of claim 1, in which the material is water

7. The method of claim 1, in which the material is an alcoholic beverage

8. The method of claim 1, in which the material is a food product or a dietary supplement

9. The method of claim 1, in which the material is a therapeutic product

10. The method of claim 2, in which the energy sensor is incorporated into a kit for the sensitive, portable evaluation of environmental products and living creatures.
